(19) United States
(12) Patent Application Publication
(10) Pub. No.: US 2026/0049673 A1
(43) Pub. Date: Feb. 19, 2026

(54) ACTUATOR DEVICE, METHOD AND ELECTRONIC MONITORING DEVICE FOR MONITORING AN OPERATIONAL RELATIONSHIP BETWEEN A TRIGGERING OF A SWITCHING FUNCTION AND A CHECK SIGNAL

(71) Applicant: Samson Aktiengesellschaft, Frankfurt am Main (DE)

(72) Inventors: David Wagner-Stürz, Mühltal (DE); Jens Bieger, Mörfelden-Walldorf (DE); Guido König, Freigericht (DE); Daniel Herzmann, Frankfurt (DE); Torsten Jung, Frankfurt (DE)

(73) Assignee: Samson Aktiengesellschaft, Frankfurt am Main (DE)

(21) Appl. No.: 19/303,739

(22) Filed: Aug. 19, 2025

(30) Foreign Application Priority Data
Aug. 19, 2024 (DE) 102024123659.0

(51) Int. Cl. F16K 37/00

(52) U.S. Cl. CPC F16K 37/0083

(57) ABSTRACT

An actuator device for a process engineering plant, such as a chemical, power, or food processing plant, may include a pneumatically operated control valve with an electric actuator. The actuator, which may function as a drive or as part of a control or safety valve, can support the operating state(s) for executing a safety function, such as moving the valve to a defined safety position. The device may also include at least one sensor configured to detect the actuator's ability to perform the safety function and to transmit a corresponding signal. An electronic monitoring unit, which may be separate from the actuator, can feature a functionally safe output for triggering the actuator and a functionally safe input for receiving the sensor signal. The monitoring unit may be configured to assess the operational relationship between the received signal and the actuator's triggering to ensure reliable execution of the safety function.

### CROSS REFERENCE TO RELATED APPLICATIONS

This patent application claims priority to German Patent Application No. 102024123659.0, filed Aug. 19, 2024, which is incorporated herein by reference in its entirety.

### BACKGROUND

The disclosure relates to an actuator device of a process engineering plant, such as a chemical plant, a power plant, a food processing plant, or the like, which may have control valve (e.g., pneumatically operated control valve) and an electronic monitoring device. The disclosure further relates to a method of the electronic monitoring device for monitoring a test function of the control valve.

From technical devices of any type, which are to be understood as meaning both individual machines and entire process engineering systems, certain hazards come not only directly for the operating personnel but also indirectly for the environment and thus for uninvolved persons. The type and the extent of the hazards depend here on a multiplicity of factors, such as, for example, on the properties of the respective technical device itself, but also on the operation thereof. Against this background, the legislator already prescribes the creation of a risk and hazard analysis in the planning phase of such hazardous technical devices. The identified risks and hazards in the intended operation of the technical device can be lowered to an acceptable level by the structural design of the technical device in accordance with legally stipulated regulations.

With complex technical devices, such as process engineering systems, a so-called process control or process control system (PCS for short; also: basic process control system, BPCS for short) is required for establishing and maintaining an intended operating state. In that a process control system can correct deviations from the intended operating state which move within a limited range, it makes a contribution to the safe operation of a process engineering plant. To ensure that even strong deviations from the intended operating state which go beyond the corrective capability of the process control system do not lead to a safety-relevant event, process engineering plants are additionally equipped with a safety instrumented system (SIS for short) independent of the process control system. While the process control system, in addition to its actual task—namely the process control—also makes a contribution to the safety of the process engineering plant to a certain extent, the task of the safety system consists solely in transferring the process engineering plant back into a safe state in the event of safety-critical operating states occurring. For this purpose, a safety instrumented system (SIS) comprises at least one so-called safety instrumented function (SIF for short), which is generally implemented in the form of a sensor, an actuator and an electronic safety-oriented controller, which is also referred to as a logic module. The safety-oriented controller determines—independently of the process control system—on the basis of the information supplied by the sensors whether a safety-critical operating state of the process engineering plant is present and whether an intervention of the safety system in the form of the execution of a safety-instrumented function, which is also referred to as a safety function, is required.

Although it is the task of the safety system to transfer a process engineering plant reliably into a safe state in the event of a safety-critical operating state occurring, there is of course also the risk of a malfunction or a failure for the safety system. The associated probability must be considered in the creation of a risk and hazard analysis of a process engineering plant. Depending on the requirements for the safety of the process engineering plant in its totality, certain requirements result for the failure safety of the safety system. These requirements for the failure safety of a safety function are quantified by means of a so-called safety integrity level (SIL for short), which indicates the probability of failure in case of need. A probability of failure in case of need of >=10⁻² to <10⁻¹ is referred to as SIL1, a probability of failure in case of need of >=10⁻³ to <10⁻² as SIL2, a probability of failure in case of need of >=10⁻⁴ to <10⁻³ as SIL3 and finally a probability of failure in case of need of >=10⁻⁵ to <10⁻⁴ as SIL4. Equivalently, a safety integrity level can also be expressed by the corresponding risk reduction factor: thus SIL1 corresponds to a risk reduction factor of 10 to 100, SIL2 corresponds to a risk reduction factor of 100 to 1000, SIL3 corresponds to a risk reduction factor of 1000 to 10 000 and SIL4 corresponds to a risk reduction factor of 10 000 to 100 000.

According to the requirements with respect to the probability of failure in case of need, which are placed on a safety-instrumented function, the components used for implementing the safety-instrumented function must also have a SIL certification of the required level. In order to demonstrate the functional capability of the individual components, regular checks are required.

In the case of a safety-instrumented function, the actuator of which is designed in the form of a control valve, a safety-instrumented function can consist, for example, in transferring the control valve from a permanently open state into a closed state. In order that the control valve, in case of need, also actually closes and does not, for instance, sit firmly, its functional capability must be checked at regular intervals. Such a functionality check comprises not only the checking of whether the valve spindle is movable at all, but also whether it is movable over the entire actuating travel. While the first-mentioned check can be carried out by means of a so-called partial stroke test (PST) during the ongoing operation of the process engineering plant, a full stroke test (FST) is generally accompanied by a temporary process shutdown and consequently by financial losses for the operator of the process engineering plant.

For this reason, the number of full-stroke tests is restricted to the minimum absolutely necessary for ensuring the SIL requirements, and the termination thereof is matched to downtime and maintenance periods planned in any case. In order to lengthen the intervals between full-stroke tests—within the limits set by the SIL requirements—partial-stroke tests can be carried out to an increasing extent. The carrying out of a relatively large number of partial-stroke tests does, on the one hand, prevent financial losses for the operator of a process engineering plant, which would arise as a result of a process shutdown, but, on the other hand, entails an increased personnel outlay. In addition, a relatively large number of partial-stroke tests to be carried out is accompanied not only by an increased documentation outlay, but also, on account of the risk of human errors that can never be ruled out, by an increased risk of an inadequate execution of a partial-stroke test.

Against this background, the German publication document DE 10 2004 015 617 A1 is concerned with the question of how the risk of a human error during the carrying out of a partial-stroke test on a control valve can be eliminated or at least reduced. The starting point of the publication document DE 10 2004 015 617 A1 is formed by a safety system (“safety system”) which is integrated into a process control system (“process control system”) and which is used in process engineering plants. The field devices of the process engineering plant can in this case be equipped with so-called online self-testing routines (on-line self-tests), which are stored on the field devices. In order to trigger these online self-testing routines, the maintenance personnel must temporarily connect a further device to the field device to be checked, which further device is equipped with a corresponding maintenance software and can trigger the online self-testing routines. The publication document DE 10 2004 015 617 A1 designates the hazards associated with the use of maintenance personnel, such as, for example, an inadequate execution of the test or a test at the wrong time, as disadvantages. As a further disadvantage of a manual triggering of the online self-testing routines by the maintenance personnel, the publication document DE 10 2004 015 617 A1 mentions the risk that the test is indeed carried out correctly and in good time, but the process control and safety system nevertheless acquires no knowledge of the test results as a result of a human omission.

In order to completely eliminate or at least minimize these hazards associated with the use of maintenance personnel, the publication document DE 10 2004 015 617 A1 proposes the use of so-called testing blocks (“testing blocks”), which are located in the network hierarchy (see FIG. 2) at the level of so-called input/output devices (“input output (I/O) devices”) and therefore above the level of the field devices. Said test blocks communicate with the field devices and trigger the online self-testing routines (on-line self-tests) stored in the field devices. The test blocks are further able to detect the results of the online self-testing routines and to transmit them to higher levels in the network hierarchy (see FIG. 2), which enables the user located at the level of the workstations to monitor the operating status of the field devices. The use of test blocks according to the publication document DE 10 2004 015 617 A1 eliminates the need for maintenance personnel, which triggers the online self-testing routines stored in the field devices, and therefore also the disadvantages associated therewith.

Despite the automated remote triggering of the online self-testing routines by the test blocks and their ability to transmit the results of the online self-testing routines to the user located at a higher level, the publication document DE 10 2004 015 617 A1 does not fully exploit the potential of the test blocks. It is therefore the object of the disclosure to overcome the disadvantages of conventional techniques, in particular to provide an actuator device with a control valve, for which an operational relationship between a trigger signal, which triggers a test function of an electric actuator of the control valve, and a check signal, which describes the check of the execution of the test function, is monitored by means of an electronic monitoring device.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1A shows an actuator device according to one or more exemplary embodiments of the disclosure.

FIG. 1B actuator device according to one or more exemplary embodiments of the disclosure.

FIG. 2 shows an actuator device for a solenoid valve test according to one or more exemplary embodiments of the disclosure.

FIG. 3 shows a schematic illustration of a safety system of a process engineering plant according to one or more exemplary embodiments of the disclosure.

The exemplary embodiments of the present disclosure will be described with reference to the accompanying drawings. Elements, features and components that are identical, functionally identical and have the same effect are-insofar as is not stated otherwise-respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

According to the disclosure, an actuator device of a process engineering plant, such as a chemical plant, a power plant, a food processing plant or the like, having a (e.g., pneumatically operated) control valve is provided.

According to the disclosure, the control valve may comprise an electric actuator, such as a drive or a control or safety valve, which is provided in at least one operating state for a safety function of the control valve, such as a movement into a safety position.

According to the disclosure, the control valve additionally may comprise at least one sensor for checking a switching capability of the electric actuator for the safety function and for transmitting a check signal describing the switching capability.

According to the disclosure, the control valve additionally may comprise an electronic monitoring device, such as formed separately from the electric actuator.

According to the disclosure, the electronic monitoring device, such as formed separately from the electric actuator, may comprise an output configured in a functionally safe manner for triggering a switching function of the electric actuator, and an input configured in a functionally safe manner for receiving the check signal of the at least one sensor.

According to the disclosure, an electronics system of the electronic monitoring device is designed such that an operational relationship between the check signal and the triggering signal is monitored.

According to an exemplary embodiment of the actuator device, which can be combined with other exemplary embodiments, the electric actuator can be a safety valve, such as a solenoid valve.

According to an exemplary embodiment of the actuator device, which can be combined with other exemplary embodiments, a position of an actuator of the control valve can remain substantially unchanged during the triggering of the switching function during the checking of the switching capability of the electric actuator.

According to an exemplary embodiment of the actuator device, which can be combined with other exemplary embodiments, the electronic monitoring device can be designed to be intrinsically safe.

According to an exemplary embodiment of the actuator device, which can be combined with other exemplary embodiments, the energy supply of the electronic monitoring device can take place via an Ethernet APL connection.

According to an exemplary embodiment of the actuator device, which can be combined with other exemplary embodiments, the energy supply of the electric actuator and/or of the at least one sensor can take place by the electronic monitoring device.

According to an exemplary embodiment of the actuator device, which can be combined with other exemplary embodiments, the electronic monitoring device can be connected to a safety system of the process engineering plant via an Ethernet APL connection.

According to an exemplary embodiment of the actuator device, which can be combined with other exemplary embodiments, the at least one (e.g., SIL-certified) sensor can be a pressure sensor.

According to an exemplary embodiment of the actuator device, which can be combined with other exemplary embodiments, the at least one (e.g., SIL-certified) sensor can be a limit contactor and the control valve can additionally comprise a (e.g., SIL-certified) stroke sensor.

According to an exemplary embodiment of the actuator device, which can be combined with other exemplary embodiments, the functionally safe communication protocol can be a PROFIsafe protocol or a CIPsafety protocol.

According to an exemplary embodiment of the actuator device, which can be combined with other exemplary embodiments, the triggering of a switching function of the electric actuator can be a movement of a component (e.g., an armature) of the actuator.

According to an exemplary embodiment of the actuator device, which can be combined with other exemplary embodiments, the check signal describing the switching capability can contain information about a start, an end and/or a course of the switching function.

According to an exemplary embodiment of the actuator device, which can be combined with other exemplary embodiments, the information about the course of the execution of the test functions can indicate the switching of a limit contact, the duration until the switching of a limit contact, the duration until the switching as well as the duration until the switching back of a limit contact, the evaluation of a time course of a stroke movement, the evaluation of a completed stroke, the evaluation of a time course of a pressure, the evaluation of a pressure difference and/or the evaluation of a pressure change rate.

According to an exemplary embodiment of the actuator device, which can be combined with other exemplary embodiments, the monitoring of an operational relationship between the check signal and the trigger signal can comprise a determination of the presence of a specific signal course in the check signal, which in particular can correlate in time with the triggering of the switching function.

According to an exemplary embodiment of the actuator device, which can be combined with other exemplary embodiments, the monitoring of an operational relationship between the check signal and the trigger signal can comprise a determination of a time offset between the two signals and a comparison of the time offset with a stored or earlier determined reference value.

According to an exemplary embodiment of the actuator device, which can be combined with other exemplary embodiments, the electronic monitoring device can comprise a further connection, which can be configured in a functionally safe manner and via which the electronic monitoring device can be connected to a safety system.

According to an exemplary embodiment of the actuator device, which can be combined with other exemplary embodiments, the further connection configured in a functionally safe manner can comprise a combination of a functionally safe communication protocol and a communication connection acting as a black channel.

According to the disclosure, a method of an electronic monitoring device, such as formed separately from an electrical actuator, for an actuator device of a process engineering plant, such as a chemical plant, a power plant, a food processing plant or the like, is provided. The actuator device may comprise a (e.g., pneumatically operated) control valve. The control valve may comprise:
an electric actuator, which is provided in at least one operating state for a safety function of the control valve, such as a movement into a safety position, and
at least one sensor for checking a switching capability of the electric actuator for the safety function and for transmitting a check signal describing the switching capability.

According to the disclosure, the method may comprise triggering a switching function of the electric actuator at an output configured in a functionally safe manner of the electronic monitoring device.

According to the disclosure, the method further may comprise receiving a check signal of the at least one sensor at an input configured in a functionally safe manner of the electronic monitoring device.

According to the disclosure, the method furthermore may comprise monitoring an operational relationship between the check signal and the triggering of the switching function by an electronics system of the electronic monitoring device.

According to an exemplary embodiment of the method, which can be combined with other exemplary embodiments, the electric actuator can be a safety valve, such as a solenoid valve.

According to an exemplary embodiment of the method, which can be combined with other exemplary embodiments, a position of an actuator of the control valve can remain substantially unchanged during the triggering of the switching function during the checking of the switching capability of the electric actuator.

According to an exemplary embodiment of the method, which can be combined with other exemplary embodiments, the electronic monitoring device can be designed to be intrinsically safe.

According to an exemplary embodiment of the method, which can be combined with other exemplary embodiments, the energy supply of the electronic monitoring device can take place via an Ethernet APL connection.

According to an exemplary embodiment of the method, which can be combined with other exemplary embodiments, the energy supply of the electric actuator and/or of the at least one sensor can take place by the electronic monitoring device.

According to an exemplary embodiment of the method, which can be combined with other exemplary embodiments, the electronic monitoring device can be connected to a safety system of the process engineering plant via an Ethernet APL connection.

According to an exemplary embodiment of the method, which can be combined with other exemplary embodiments, the at least one (e.g., SIL-certified) sensor can be a pressure sensor.

According to an exemplary embodiment of the method, which can be combined with other exemplary embodiments, the at least one (e.g., SIL-certified) sensor can be a limit contactor and the control valve can additionally comprise a (e.g., SIL-certified) stroke sensor.

According to an exemplary embodiment of the method, which can be combined with other exemplary embodiments, the functionally safe communication protocol can be a PROFIsafe protocol or a CIPsafety protocol.

According to an exemplary embodiment of the method, which can be combined with other exemplary embodiments, the triggering of a switching function of the electric actuator can be a movement of a component (e.g., an armature) of the actuator.

According to an exemplary embodiment of the method, which can be combined with other exemplary embodiments, the check signal describing the switching capability can contain information about a start, an end and/or a course of the switching function.

According to an exemplary embodiment of the method, which can be combined with other exemplary embodiments, the information about the course of the execution of the test functions can indicate the switching of a limit contact, the duration until the switching of a limit contact, the duration until the switching as well as the duration until the switching back of a limit contact, the evaluation of a time course of a stroke movement, the evaluation of a completed stroke, the evaluation of a time course of a pressure, the evaluation of a pressure difference and/or the evaluation of a pressure change rate.

According to an exemplary embodiment of the method, which can be combined with other exemplary embodiments, the monitoring of an operational relationship between the check signal and the trigger signal can comprise a determination of the presence of a specific signal course in the check signal, which in particular can correlate in time with the triggering of the switching function.

According to an exemplary embodiment of the method, which can be combined with other exemplary embodiments, the monitoring of an operational relationship between the check signal and the trigger signal can comprise a determination of a time offset between the two signals and a comparison of the time offset with a stored or earlier determined reference value.

According to an exemplary embodiment of the method, which can be combined with other exemplary embodiments, the electronic monitoring device can comprise a further connection, which can be configured in a functionally safe manner and via which the electronic monitoring device can be connected to a safety system.

According to an exemplary embodiment of the method, which can be combined with other exemplary embodiments, the further connection configured in a functionally safe manner can comprise a combination of a functionally safe communication protocol and a communication connection acting as a black channel.

According to the disclosure, an electronic monitoring device for an actuator device of a process engineering plant, such as a chemical plant, a power plant, a food processing plant or the like, is provided. The actuator device may comprise a (e.g., pneumatically operated) control valve. The control valve may comprise:
an electric actuator, which is provided in at least one operating state for a safety function of the control valve, such as a movement into a safety position, and
at least one sensor for checking a switching capability of the electric actuator for the safety function and for transmitting a check signal describing the switching capability.

According to the disclosure, the electronic monitoring device may comprise an output configured in a functionally safe manner for triggering a switching function of the electric actuator.

According to the disclosure, the electronic monitoring device furthermore may comprise an input configured in a functionally safe manner for receiving the check signal of the at least one sensor.

According to the disclosure, an electronics system of the electronic monitoring device is designed such that an operational relationship between the check signal and the triggering of the switching function is monitored.

According to an exemplary embodiment of the electronic monitoring device, which can be combined with other exemplary embodiments, the electric actuator can be a safety valve, such as a solenoid valve.

According to an exemplary embodiment of the electronic monitoring device, which can be combined with other exemplary embodiments, a position of an actuator of the control valve can remain substantially unchanged during the triggering of the switching function during the checking of the switching capability of the electric actuator.

According to an exemplary embodiment of the electronic monitoring device, which can be combined with other exemplary embodiments, the electronic monitoring device can be designed to be intrinsically safe.

According to an exemplary embodiment of the electronic monitoring device, which can be combined with other exemplary embodiments, the energy supply of the electronic monitoring device can take place via an Ethernet APL connection.

According to an exemplary embodiment of the electronic monitoring device, which can be combined with other exemplary embodiments, the energy supply of the electric actuator and/or of the at least one sensor can take place by the electronic monitoring device.

According to an exemplary embodiment of the electronic monitoring device, which can be combined with other exemplary embodiments, the electronic monitoring device can be connected to a safety system of the process engineering plant via an Ethernet APL connection.

According to an exemplary embodiment of the electronic monitoring device, which can be combined with other exemplary embodiments, the at least one SIL-certified) sensor can be a pressure sensor.

According to an exemplary embodiment of the electronic monitoring device, which can be combined with other exemplary embodiments, the at least one (e.g., SIL-certified) sensor can be a limit contactor and the control valve can additionally comprise a (e.g., SIL-certified) stroke sensor.

According to an exemplary embodiment of the electronic monitoring device, which can be combined with other exemplary embodiments, the functionally safe communication protocol can be a PROFIsafe protocol or a CIPsafety protocol.

According to an exemplary embodiment of the electronic monitoring device, which can be combined with other exemplary embodiments, the triggering of a switching function of the electric actuator can be a movement of a component, such as an armature, of the actuator.

According to an exemplary embodiment of the electronic monitoring device, which can be combined with other exemplary embodiments, the check signal describing the switching capability can contain information about a start, an end and/or a course of the switching function.

According to an exemplary embodiment of the electronic monitoring device, which can be combined with other exemplary embodiments, the information about the course of the execution of the test functions can indicate the switching of a limit contact, the duration until the switching of a limit contact, the duration until the switching as well as the duration until the switching back of a limit contact, the evaluation of a time course of a stroke movement, the evaluation of a completed stroke, the evaluation of a time course of a pressure, the evaluation of a pressure difference and/or the evaluation of a pressure change rate.

According to an exemplary embodiment of the electronic monitoring device, which can be combined with other exemplary embodiments, the monitoring of an operational relationship between the check signal and the trigger signal can comprise a determination of the presence of a specific signal course in the check signal, which in particular can correlate in time with the triggering of the switching function.

According to an exemplary embodiment of the electronic monitoring device, which can be combined with other exemplary embodiments, the monitoring of an operational relationship between the check signal and the trigger signal can comprise a determination of a time offset between the two signals and a comparison of the time offset with a stored or earlier determined reference value.

According to an exemplary embodiment of the electronic monitoring device, which can be combined with other exemplary embodiments, the electronic monitoring device can comprise a further connection, which can be configured in a functionally safe manner and via which the electronic monitoring device can be connected to a safety system.

According to an exemplary embodiment of the electronic monitoring device, which can be combined with other exemplary embodiments, the further connection configured in a functionally safe manner can comprise a combination of a functionally safe communication protocol and a communication connection acting as a black channel.

According to an exemplary embodiment of the actuator device, which can be combined with other exemplary embodiments, the control valve can comprise an electric actuator, such as in particular an I/P converter or a solenoid valve of a position controller or a drive or an independent solenoid valve, which is provided for carrying out a test function; at least one sensor for checking the execution of the test function and for transmitting a check signal describing the execution of the test function; and an electronic monitoring device, such as formed separately from the electric actuator, wherein the electronic monitoring device, such as formed separately from the electric actuator, can comprise an input for receiving an electric triggering signal, which signals a time of the triggering of the test function, and a further input, which is configured in a functionally safe manner, for receiving the check signal of the at least one sensor, wherein an electronics system of the electronic monitoring device can be designed such that an operational relationship between the check signal and the triggering signal can be monitored.

According to an exemplary embodiment of the actuator device, which can be combined with other exemplary embodiments, the at least one (e.g., SIL-certified) sensor can be a limit contactor, a pressure sensor or a stroke sensor.

According to an exemplary embodiment of the actuator device, which can be combined with other exemplary embodiments, the trigger signal can be a binary signal output by the electric actuator.

According to an exemplary embodiment of the actuator device, which can be combined with other exemplary embodiments, the input for receiving an electric trigger signal can be configured in a functionally safe manner and can be connected to a safety circuit of the process engineering plant via an Ethernet APL connection.

According to an exemplary embodiment of the actuator device, which can be combined with other exemplary embodiments, the input configured in a functionally safe manner can comprise a combination of a functionally safe communication protocol and a communication connection acting as a black channel.

According to an exemplary embodiment of the actuator device, which can be combined with other exemplary embodiments, the functionally safe communication protocol can be a PROFIsafe protocol or a CIPsafety protocol.

According to an exemplary embodiment of the actuator device, which can be combined with other exemplary embodiments, the communication connection acting as a black channel can be an Ethernet APL connection.

According to an exemplary embodiment of the actuator device, which can be combined with other exemplary embodiments, the execution of a test function can be the execution of a partial-stroke or full-stroke test of the control valve.

According to an exemplary embodiment of the actuator device, which can be combined with other exemplary embodiments, the check signal describing the execution of the test function can contain information about a start, an end and/or a course of the execution of the test function.

According to an exemplary embodiment of the actuator device, which can be combined with other exemplary embodiments, the information about the course of the execution of the test functions can indicate the switching of a limit contact, the duration until the switching of a limit contact, the duration until the switching as well as the duration until the switching back of a limit contact, the evaluation of a time course of a stroke movement, the evaluation of a completed stroke, the evaluation of a time course of a pressure, the evaluation of a pressure difference and/or the evaluation of a pressure change rate.

According to an exemplary embodiment of the actuator device, which can be combined with other exemplary embodiments, the check signal describing the execution of the test function can contain information about a time course of the execution of the test function, wherein the monitoring of an operational relationship between the check signal and the trigger signal can comprise a division of the time course into different movement ranges of the test function.

According to an exemplary embodiment of the actuator device, which can be combined with other exemplary embodiments, the monitoring of an operational relationship between the check signal and the trigger signal can comprise a determination of the presence of a specific signal course in the check signal, which in particular can correlate in time with the triggering of the switching function.

According to an exemplary embodiment of the actuator device, which can be combined with other exemplary embodiments, the monitoring of an operational relationship between the check signal and the trigger signal can comprise a determination of a time offset between the two signals and a comparison of the time offset with a stored or earlier determined reference value.

According to an exemplary embodiment of the actuator device, which can be combined with other exemplary embodiments, the electronic monitoring device can comprise an output, which may be configured in a functionally safe manner, for an output of a control signal to the electric actuator depending on the trigger signal, wherein the control signal can be provided to control the actuator for triggering the test function.

According to an exemplary embodiment of the actuator device, which can be combined with other exemplary embodiments, the output, in particular configured in a functionally safe manner, for an output of a control signal to the electric actuator can comprise a combination of a functionally safe communication protocol and a communication connection acting as a black channel.

According to an exemplary embodiment of the method, which can be combined with other exemplary embodiments, the method can comprise transmitting a check signal describing the execution of the test function; receiving an electrical trigger signal for the test function at an input of the electronic monitoring device, wherein the trigger signal signals a point in time of the triggering of the execution of the test function; receiving a check signal of the at least one sensor at a further input of the electronic monitoring device, wherein the further input is configured in a safe manner; and monitoring an operational relationship between the check signal and the trigger signal by an electronics system of the electronic monitoring device.

According to an exemplary embodiment of the method, which can be combined with other exemplary embodiments, the at least one (e.g., SIL-certified) sensor can be a limit contactor, a pressure sensor or a stroke sensor.

According to an exemplary embodiment of the method, which can be combined with other exemplary embodiments, the trigger signal can be a binary signal output by the electric actuator.

According to an exemplary embodiment of the method, which can be combined with other exemplary embodiments, an input for receiving an electric trigger signal can be configured in a functionally safe manner and can be connected to a safety circuit of the process engineering plant via an Ethernet APL connection.

According to an exemplary embodiment of the method, which can be combined with other exemplary embodiments, the input configured in a functionally safe manner can comprise a combination of a functionally safe communication protocol and a communication connection acting as a black channel.

According to an exemplary embodiment of the method, which can be combined with other exemplary embodiments, the functionally safe communication protocol can be a PROFIsafe protocol or CIPsafety protocol.

According to an exemplary embodiment of the method, which can be combined with other exemplary embodiments, the communication connection acting as a black channel can be an Ethernet APL connection.

According to an exemplary embodiment of the method, which can be combined with other exemplary embodiments, the execution of a test function can be the execution of a partial-stroke or full-stroke test.

According to an exemplary embodiment of the method, which can be combined with other exemplary embodiments, the check signal describing the execution of the test function can contain information about a start, an end and/or a course of the execution of the test function.

According to an exemplary embodiment of the method, which can be combined with other exemplary embodiments, the information about the course of the execution of the test functions can indicate the switching of a limit contact, the duration until the switching of a limit contact, the duration until the switching as well as the duration until the switching back of a limit contact, the evaluation of a time course of a stroke movement, the evaluation of a completed stroke, the evaluation of a time course of a pressure, the evaluation of a pressure difference and/or the evaluation of a pressure change rate.

According to an exemplary embodiment of the method, which can be combined with other exemplary embodiments, the check signal describing the execution of the test function can contain information about a time course of the execution of the test function, wherein the monitoring of an operational relationship between the check signal and the trigger signal can comprise a division of the time course into different movement ranges of the test function.

According to an exemplary embodiment of the method, which can be combined with other exemplary embodiments, the monitoring of an operational relationship between the check signal and the trigger signal can consist in a determination of the presence of a specific signal course in the check signal, which in particular can correlate in time with the triggering of the switching function.

According to an exemplary embodiment of the method, which can be combined with other exemplary embodiments, the monitoring of an operational relationship between the check signal and the trigger signal can comprise a determination of a time offset between the two signals and a comparison of the time offset with a stored or earlier determined reference value.

According to an exemplary embodiment of the method, which can be combined with other exemplary embodiments, the output, in particular configured in a functionally safe manner, for an output of a control signal to the electric actuator can comprise a combination of a functionally safe communication protocol and a communication connection acting as a black channel.

According to the disclosure, an electronic monitoring device for an actuator device of a process engineering plant, such as a chemical plant, a power plant, a food processing plant or the like, is provided.

According to an exemplary embodiment of the electronic monitoring device, which can be combined with other exemplary embodiments, the electronic monitoring device can comprise an input for receiving an electrical triggering signal, which signals a time of the triggering of a test function of an electric actuator, such as in particular an I/P converter or a solenoid valve of a position controller or a drive or an independent solenoid valve; a further input, which is configured in a functionally safe manner, for receiving a check signal of at least one sensor, which is provided for checking the execution of the test function and for transmitting a check signal describing the execution of the test function, wherein the electronic monitoring device can be formed separately from the electric actuator, with an electronics system which can be designed such that an operational relationship between the check signal and the triggering signal can be monitored.

According to an exemplary embodiment of the electronic monitoring device, which can be combined with other exemplary embodiments, the at least one (e.g., SIL-certified) sensor can be a limit contactor, a pressure sensor or a stroke sensor.

According to an exemplary embodiment of the electronic monitoring device, which can be combined with other exemplary embodiments, the trigger signal can be a binary signal output by the electric actuator.

According to an exemplary embodiment of the electronic monitoring device, which can be combined with other exemplary embodiments, the input for receiving an electric trigger signal can be configured in a functionally safe manner and can be connected to a safety circuit of the process engineering plant via an Ethernet APL connection.

According to an exemplary embodiment of the electronic monitoring device, which can be combined with other exemplary embodiments, the input configured in a functionally safe manner can comprise a combination of a functionally safe communication protocol and a communication connection acting as a black channel.

According to an exemplary embodiment of the electronic monitoring device, which can be combined with other exemplary embodiments, the functionally safe communication protocol can be a PROFIsafe protocol or a CIPsafety protocol.

According to an exemplary embodiment of the electronic monitoring device, which can be combined with other exemplary embodiments, the communication connection acting as a black channel can be an Ethernet APL connection.

According to an exemplary embodiment of the electronic monitoring device, which can be combined with other exemplary embodiments, the execution of a test function can be the execution of a partial-stroke or full-stroke test.

According to an exemplary embodiment of the electronic monitoring device, which can be combined with other exemplary embodiments, the check signal describing the execution of the test function can contain information about a start, an end and/or a course of the execution of the test function.

According to an exemplary embodiment of the electronic monitoring device, which can be combined with other exemplary embodiments, the information about the course of the execution of the test functions can indicate the switching of a limit contact, the duration until the switching of a limit contact, the duration until the switching as well as the duration until the switching back of a limit contact, the evaluation of a time course of a stroke movement, the evaluation of a completed stroke, the evaluation of a time course of a pressure, the evaluation of a pressure difference and/or the evaluation of a pressure change rate.

According to an exemplary embodiment of the electronic monitoring device, which can be combined with other exemplary embodiments, the check signal describing the execution of the test function can contain information about a time course of the execution of the test function, wherein the monitoring of an operational relationship between the check signal and the triggering signal can comprise a division of the time course into different movement ranges of the test function.

According to an exemplary embodiment of the electronic monitoring device, which can be combined with other exemplary embodiments, the monitoring of an operational relationship between the check signal and the trigger signal can consist in a determination of the presence of a specific signal course in the check signal, which in particular can correlate in time with the triggering of the switching function.

According to an exemplary embodiment of the electronic monitoring device, which can be combined with other exemplary embodiments, the monitoring of an operational relationship between the check signal and the triggering signal can comprise a determination of a time offset between the two signals and a comparison of the time offset with a stored or earlier determined reference value.

According to an exemplary embodiment of the electronic monitoring device, which can be combined with other exemplary embodiments, the output configured in a functionally safe manner for an output of a control signal to the electric actuator can comprise a combination of a functionally safe communication protocol and a communication connection acting as a black channel.

According to an exemplary embodiment of the electronic monitoring device, which can be combined with other exemplary embodiments, the electronics system of the electronic monitoring device, such as a computing unit (computer, processor), can be configured in a functionally safe manner.

A “driver”, which can optionally also be referred to as an “actuator”, may be a drive element which converts electric, pneumatic, hydraulic or other input signals into mechanical movements or into the change of physical variables as output signals. Depending on the type of the input signal and optionally of the output signal, actuators can be divided into different categories, such as, for example, mechanical, acoustic, thermal or pneumatic actuators. Thus, for example, an actuator which converts an electric input signal into a pneumatic output signal can be referred to as an electric or—specific—electropneumatic actuator. Such an electric or electropneumatic actuator can be, for example, an I/P converter. Especially in the context of actuators, both the actuator in its totality as well as only a part of the actuator can be referred to as an actuator. Such a part of an actuator can for example be an actuator drive.

An “actuator drive”, which for short can also be referred to as a “drive”, may be that part of an actuator which generates the movement of the actuator. Actuators can be classified here according to the type of auxiliary energy used (pneumatic, hydraulic, electromagnetic, manual, etc.), according to the construction principle (piston, diaphragm, magnet coil, handwheel, hand lever, etc.) and/or according to the type of the actuating movement (rectilinear, pivoting, rotating, etc.). A typical example of actuators in process engineering plants—in particular in explosion-endangered environments—are pneumatic actuators.

A “position controller”, which can optionally also be referred to as a “positioner”, may be an accessory for control valves, the basic task of which is to compare the position of the valve spindle or the valve shaft as a controlled variable with an input signal as a reference variable and in the event of deviations of the controlled variable from the reference variable to change the control pressure such that the controlled variable adapts to or at least approximates the reference variable. While older position controllers receive the reference variable in the form of pneumatic input signals, modern position controllers are usually digital position controllers which can receive the reference variable in the form of electrical signals. These signals can be processed by executing algorithms on a microprocessor (and/or other processing circuitry) of the digital position controller, which can in turn output an electrical signal as an output variable to a current/pressure converter (I/P converter for short). The I/P converter can for its part output a pressure signal which can either be intended directly for a pneumatic actuator or—which is regularly the case—can initially still be amplified by a pressure amplifier. In the case of electric actuators, i.e. for actuators which use electrical energy as auxiliary energy, the need for an I/P converter and the need for a pressure amplifier can be eliminated. If an I/P converter is not considered as a separate component but rather is counted as part of the position controller, then reference can be made to electropneumatic position controllers. Such microprocessor-controlled, electropneumatic position controllers can form the standard in modern process engineering plants.

A “solenoid valve” may be a valve which is installed in the pneumatic connecting line between a position controller and a pneumatic actuator drive and can be switched by means of an electromagnet. Depending on the intended function of the solenoid valve in the case of a power failure, the switching off of the electromagnet can either lead to venting of the actuator drive or to the air located in the actuator drive being enclosed there. Through the use of an electromagnet, solenoid valves can switch very rapidly, which can represent an important property in particular with regard to safety functions.

A “safety function”, which can also be referred to as a “safety instrumented function” (SIF for short), may be a routine to be carried out during the determination of a safety-critical operating state of the process engineering plant, with which routine the process engineering plant can be transferred back into a safe state. In the case of a “safety function of a control valve”, the transfer of the control valve into a safe state can comprise, for example, the movement into a safety position. A “safety position” can be, for example, a completely closed state or a completely open state of the control valve.

A “sensor” may be the counterpart of an actuator in a control loop: While an actuator as a drive element can convert electric, pneumatic, hydraulic or other input signals into mechanical movements or into the change of physical variables as output signals, a sensor can, for example, detect mechanical movements or other physical, chemical or other qualitatively or quantitatively determinable variables or states and generate an electric signal therefrom. In the special case, in which an actuator can be provided for the execution of a test function, a sensor can check the execution of the test function. The “check” can in this respect not be subject to any restriction in terms of time: Thus, the term “check” can comprise, for example, both a check taking place at one or more times, a check taking place in certain time intervals or at certain time intervals, but also a permanent check. Independently of the time dimension of the term “check”, this term can be understood both as a determination in the sense of a punctual check, but also as a monitoring in the sense of a continuous check. Especially in the case of the checking of a switching capability of an electric actuator, the checking can consist in the determination whether the electric actuator is set in motion such that an intended safety position is sought. Alternatively, or additionally, the checking of a switching capability can also consist in the determination at which time a movement of the electric actuator starts and/or with which time delay a movement of the electric actuator starts after the start of the triggering of the switching function. Likewise, the checking of the switching capability of an electric actuator can consist, for example, in the recording or determination of a time-distance, time-speed and/or time-acceleration profile of the movement of the electric actuator.

A “check signal describing the switching capability” may be a signal which can contain information about the switching capability. The “check signal” can in this case comprise only the data about the switching capability determined by an individual sensor; alternatively, the check signal can also comprise the data of a plurality of sensors. Likewise, the “check signal” can be understood as the totality of two or more signals, wherein each signal can comprise the data about the switching capability determined by an individual sensor. The “check signal describing the switching capability” can in this case generally contain all conceivable data and information which can be determined by sensors and can describe one or more aspects of the switching capability.

A check signal can originate, for example, from a limit contactor, which can also be referred to as a limit signal transmitter or limit contact. Such a check signal can indicate the switching of the contact and/or the switching back of the contact. Similarly, such a check signal can indicate the duration until the switching of the contact and/or the duration until the switching back of the contact.

A check signal can originate, for example, from a stroke sensor. Such a check signal can indicate the reaching of a defined stroke value, the evaluation of a time course of a stroke movement and/or the evaluation of the completed stroke. Similarly, such a check signal can indicate a division of the time course of the stroke movement into different movement ranges: While for a full stroke test the entire stroke travel must be completed and the check signal accordingly generally also indicates the time course of the entire stroke movement, it can be sufficient for partial stroke tests that only certain parts of the time course of the entire stroke movement are indicated.

A check signal can originate, for example, from a pressure sensor. Such a check signal can indicate the reaching of a defined pressure, the reaching of a defined pressure change, the evaluation of a time course of the pressure and/or the evaluation of a pressure difference. Similarly, such a check signal can indicate a division of the time course of the pressure into different states. Furthermore, such a check signal can indicate the evaluation of a pressure change rate or indicate information which allows the evaluation of a pressure change rate.

Examples of check signals can be one or more of the following signals:
Position feedback analogously from the position controller, 4-20 mA, externally fed at the electronic monitoring device at a functionally safe analog input (Possible functions: feedback and monitoring of the valve movement during a PST/FST or switching process; monitoring of the valve dynamics/running times; verification of the boundary contacts for the position feedback; feedback of further variables of the position controller, e.g. values of internal pressure sensors for supply air or drive pressure of the position controller)
Analog feedback signal from the position controller, 4-20 mA, externally fed at the electronic monitoring device at a functionally safe analog input (Possible functions: safe feedback and monitoring of different analog variables of the position controller on the same line via a time-multiplexed analog signal with subdivided different value ranges, such as e.g. 4-6 mA for value 1, 6-8 mA for value 2, 8-10 mA for value 3 etc. to 20 mA)
Analog feedback signal from the position controller, 4-20 mA, externally fed at the electronic monitoring device at a functionally safe analog input, additionally a digital signal in the case of the position controller and electronic monitoring device for synchronizing the switching time (Possible functions: safe feedback and monitoring of different analog variables of the position controller on the same line via a time-multiplexed analog signal with subdivided different value ranges, such as e.g. 4-6 mA for value 1, 6-8 mA for value 2, 8-10 mA for value 3 etc. to 20 mA)
Safe position feedback analogously of type 4749, 4-20 mA, externally fed at the electronic monitoring device at a functionally safe analog input (Possible functions: safe feedback and safe monitoring of the valve movement during a PST/FST or switching process; monitoring of the valve dynamics/running times, replacement of the function of the boundary contacts)
Boundary contact feedback (Possible functions: safe feedback of the reaching or leaving of the end positions; in the case of PST/FST, safe recognition of the valve movement; monitoring of the valve dynamics/running times of open/closed running time; in combination with the digital input of the position controller feedback for ongoing PST/FST)
Wear sensor packing, functionally safe digital output on functionally safe digital input of the electronic monitoring device (Possible functions: safe feedback of packing wear before the occurrence of the leakage of the valve housing)
Safe pressure sensor in the output of the solenoid valve with analog pressure measurement signal to functionally safe analog input of the electronic monitoring device (Possible functions: safe detection of the pressure drop in the case of brief switching off of the solenoid valve without the armature moving out of the end position by a short pulse at the safe digital output of the electronic monitoring device to the solenoid valve to prove the function of the solenoid valve.
Functionally safe switching output of the electronic monitoring device to the solenoid valve (Possible function: safe line breakage detection and feedback by short test pulse current)
SIL NAMUR Boundary contacts at functionally safe digital input of the electronic monitoring device (Possible functions: wire breakage monitoring or short circuit and safe feedback by NAMUR status signaling)
Functionally safe or unsafe flowmeter with analog output to functionally safe analog input of the electronic monitoring device (Possible functions: safe feedback of the line flow and monitoring of the sealing closure in combination with the safe boundary contact; safe recognition and feedback of relevant leakage; safe feedback of the line flow for monitoring the flow of a medium, e.g. for ensuring a cooling application)
Functionally safe digital output of the electronic monitoring device to a digital input of the position controller (Possible functions: safe signaling of an ongoing solenoid valve test to suppress any error messages of the position controller on account of position changes by the pressure drop of the test; safe signaling of a safety switch-off by the DIO to the position controller to suppress an error message; avoidance of the ventilation of the drive by the position controller when the safety position is actuated by the electronic monitoring device)
Functionally safe analog input with a safe pressure sensor connected for measuring the supply air pressure (Possible functions: safe feedback for ensuring the presence of the primary drive energy)
Safe analog input connected with an acceleration sensor which detects any form of vibrations at the valve (Possible functions: safe feedback of a flow or greater cavitation in the valve in the open position in combination with the boundary contacts; safe feedback of a missing flow or ensure that there is no leakage in the closed position in combination with the boundary contacts)
Functionally safe digital output of a first electronic monitoring device on a safe digital input of a second electronic monitoring device (Possible functions: at higher SIL levels (3 and higher), two valve armatures are required for execution with in each case one electronic monitoring device. There are two cases to be distinguished here:
   1.) Safety function is the safe closing: here, two actuators are connected in series (Possible functions: the first electronic monitoring device reports the safety position of its actuator back (closed) to the second electronic monitoring device via the signal. The second electronic monitoring device can then reliably carry out a complete movement test and report back. The first electronic monitoring device reports this state to the position controller via the additional safe digital output and triggers an FST/PST test.)
   2.) Safety function is the safe opening: here, two actuators are connected in parallel (Possible functions: the first electronic monitoring device reports the safety position of its actuator back (open) to the second via the signal. The second electronic monitoring device can then reliably carry out a complete movement test and report back. The first electronic monitoring device reports this state to the position controller via the additional safe digital output and triggers an FST/PST test.)
Functionally safe digital output to a (functionally safe) external device or sensor (Possible functions: the safe digital output triggers a simulation mode of a (functionally safe) analog or digital output of a device or sensor which is detected via in each case one safe input of the electronic monitoring device; thus, the (functionally safe) function of the information can be checked or diagnosed by the connected device via a predefined and internally known time sequence of expected values.)

An “electronic monitoring device” may be an electronic apparatus which can send, receive and process electrical signals. The processing of the electrical signals can in this respect take place by means of suitable algorithms using a microprocessor. “Separate formation” of an electronic monitoring device from an electric actuator can be understood to mean a separation or separability of the functionalities of the electronic monitoring device from the functionalities of the electric actuator in the sense that the functionalities of the electric actuator do not depend on the presence or absence of the electronic monitoring device. This can mean that the electronic monitoring device can be, for example, an optional device on or in the electric actuator; a separation in the sense of a physical distance of the electronic monitoring device from the electric actuator may not be necessary. Likewise, the electronic monitoring device can be retrofittable in the sense of an accessory on or in the electric actuator.

An “input” of the electronic monitoring device may be an interface of the electronic monitoring device, via which the electronic monitoring device can receive electrical signals. The received electrical signals can in this case be distinguished as to whether they relate to the process control system or the safety system. For the case in which the received electrical signals are associated with the execution or monitoring of a safety function and are thus part of the safety system, in order to be able to reach a predefined safety integrity level, the signal transmission can also satisfy the respective SIL requirements. Thus, for example, it can have to be ensured that the electrical signals are not falsified as a result of electromagnetic interferences or other influences; likewise, for example, it can have to be ensured that no external electrical signals can be introduced or electrical signals can be lost via an interface. Furthermore, for example, it can have to be ensured that the electrical signals can be received in the correct sequence and that no delays or signal repetitions can occur. In order to be able to limit the probability of the occurrence of such faults to a level which can satisfy the respective SIL requirements, an input which can be involved in the signal transmission in the safety circuit can be configured in a “functionally safe manner.”

As failsafe as possible a design of a binary electrical output for controlling a solenoid valve, in which the safe state is the currentless state, can be realized by a plurality of circuit measures and diagnostic measures. The technical aspects and measures for diagnosis and increasing the functional safety are presented in more detail below.

An SIL-compliant output stage for controlling a solenoid valve can be realized by using a relay output stage. Here, the output for controlling the solenoid valve may comprise a relay which is closed in the normal state and closes the circuit. In the event of a fault state or energy loss, the relay opens the circuit, as a result of which the safe, currentless state of the solenoid valve is reached. Similarly, an SIL-compliant output stage for controlling a solenoid valve can be realized by using a redundant power supply. In this case, a double power supply is used which may comprise a primary and a secondary voltage source. In the event of failure of the primary source, the secondary source takes over the supply.

An SIL-compliant output stage for controlling a solenoid valve can additionally be realized by including different diagnostic measures. An SIL-compliant output stage for controlling a solenoid valve can be achieved, for example, by connecting a readback input to a sensor which monitors the actual state of the solenoid valve. This sensor reports a signal back to the controller which reflects the current switching state of a relay. This gives rise to a feedback (“feedback loop”) which provides information as to whether the current switching state of a relay corresponds to the current setpoint state. An SIL-compliant output stage for controlling a solenoid valve can additionally be realized, for example, by monitoring current intensities and voltages at the solenoid valve and at the relay. Thus, a current flowing through the solenoid valve can be measured by means of a shunt resistor connected in series thereto. In addition, voltage sensors can be used to monitor the voltage at the relay output and at the solenoid valve. These sensors are connected to a monitoring unit which continuously checks the measured values and detects deviations.

The functional safety can additionally be increased by the redundant design of the control channel (“dual-channel”), by the use of diagnostic logic and by the carrying out of online self-tests. In the case of the redundant design of the control channel, a solenoid valve is actuated simultaneously via two mutually independent control channels (“dual channel”), each of which is equipped with its own relay. Both channels are designed such that they operate independently of one another, and their outputs are regularly compared with one another. An error in one of the two channels is recognized and reported by comparison with the other channel. In addition, there is the possibility of implementing a diagnostic logic in the controller which continuously checks the state of the relays, the read-back signals and the measured values of the current and voltage sensors. On recognition of a fault pattern, the logic puts the system into the safe state. Furthermore, the controller can regularly carry out self-tests in which the relay is briefly switched, and the feedback signals are checked. These self-tests are carried out automatically and during normal operation (“online”) without impairing the function of the solenoid valve.

These specific implementations ensure the functional safety according to SIL2 and SIL3 by minimizing the probability of dangerous failures and reliably putting the system into the safe state in the event of a fault.

As failsafe as possible a design of a binary electrical input, via which digital NAMUR signals are received, can also be realized by a plurality of circuit measures and diagnostic measures. The technical aspects and measures for diagnosis and increasing the functional safety are presented in more detail below.

An SIL-compliant input stage for digital NAMUR signals can be continuously monitored, for example, by using a single-precision analog-to-digital converter (ADC) in combination with a shunt resistor, the current flow through the inputs in order to ensure that it remains within the NAMUR limit values. Deviations, such as excessively low current (line interruption) or an excessively high current (short circuit), are immediately recognized and reported. Such a circuit with a high-resistance voltage divider and comparator recognizes the specific voltage levels of the NAMUR signal (0-1 mA as low and 2.1-6 mA as high). In addition, the input stage can be galvanically separated from the rest of the system by means of an optocoupler in order to ensure protection against interference voltages and overvoltages.

An SIL-compliant input stage for digital NAMUR signals can additionally be realized by including different diagnostic measures. Thus, for example, the current intensity can be continuously measured by means of a current monitoring circuit which may comprise a shunt resistor and a precise analog-to-digital converter (ADC). In the case of current intensities <0.1 mA, in this respect a line interruption is detected, whereas in the case of current intensities >6 mA a short circuit is detected. An SIL-compliant input stage for digital NAMUR signals can additionally be realized via a read-back input circuit. By an additional input circuit monitoring the actual state of an input signal and returning it to the controller, a feedback (“feedback loop”) arises with which the correct reception and state of the signal can be checked. Furthermore, an SIL-compliant input stage for digital NAMUR signals can be realized via a signal integrity check. In this case, an algorithm implemented in the controller continuously checks the signal integrity and in this manner detects anomalies in the signal profile.

The functional safety can additionally be increased by the redundant design of the input channel (“dual-channel”), by the use of diagnostic logic and by the carrying out of online self-tests. In the case of the redundant design of the input channel, two separate input channels (“dual channel”) detect the same NAMUR signal. Both channels are designed such that they operate independently of one another and their inputs are regularly compared with one another. An error in one of the two channels is recognized and reported by comparison with the other channel. In addition, there is the possibility of implementing a diagnostic logic realized in the form of a microcontroller or an FPGA (“field programmable gate array”) in the controller which continuously checks the states of the inputs, the read-back signals and the results of the line monitoring. On recognition of a fault pattern, the logic puts the system into the safe state. Furthermore, the controller can regularly carry out self-tests in that a test signal generator contained in the controller regularly sends test signals to the NAMUR inputs during normal operation (“online”). A corresponding monitoring processor checks the feedback signals and evaluates the integrity thereof. Furthermore, a precise analog-to-digital converter (ADC) in combination with a shunt resistor can continuously monitor the current flow through the inputs in order to ensure that it remains within the NAMUR limit values. Deviations, such as an excessively low current intensity which indicates a line interruption or an excessively high current intensity which indicates a short circuit, can thereby be immediately recognized and reported.

These specific implementations ensure the functional safety according to SIL2 and SIL3 for digital NAMUR signals by minimizing the probability of dangerous failures and reliably putting the system into the safe state in the event of a fault.

In addition to the measures described above for ensuring as failsafe as possible a design of a binary electrical output for controlling a solenoid valve and of a binary electrical input for receiving digital NAMUR signals, some general circuit measures and diagnostic methods which can be used to realize functionally safe binary outputs according to SIL2 and SIL3 are explained below.

In the field of circuit measures, the functional safety can in principle be increased by a redundant design of channels, components or the entire system. By using a so-called “dual-channel architecture”, in which two output channels operate independently of one another and are compared at regular intervals, errors in one of the channels can be recognized and the failure safety can thus be increased. By virtue of the fact that components or entire systems are present repeatedly and are operated simultaneously, it is possible to switch over to a redundant system in the case of a fault.

A further circuit measure for increasing the functional safety consists in diversifying both the hardware used, and the software used. By using different hardware and software components in parallel channels for error recognition and error avoidance, the functional safety can be increased since different implementations are less likely to have the same error. Thus, for example, in one channel a relay can be used as a switch, whereas in a parallel channel, in contrast, a MOSFET is used as a switch.

The functional safety can furthermore be increased by using so-called “watchdog timers”: These monitoring circuits ensure that the system regularly checks its own function and, in the case of anomalies, transitions safely into a defined state.

In principle, the functional safety can be increased by virtue of circuits being designed such that, in the event of an error occurring, a safe state (e.g. switching off of a machine) is automatically assumed. The use of components which are designed for higher current intensities and voltages than occur or are required in normal operation can also increase the failure safety.

A further circuit measure for increasing the functional safety consists in the integration of self-test mechanisms (“built-in self-test”) which periodically or if necessary, check the function of the hardware. This increases the probability that an error is recognized in good time—or at all—and corresponding measures can be initiated.

In addition to the purely circuit measures, diagnostic measures can also contribute to an increase in the functional safety.

In the field of diagnostic measures, functional safety can in principle be increased by measures for error recognition and error diagnosis. This can take place, for example, by means of the calculation and the comparison of check bits (“parity check”) and check sums (“cyclic redundancy check”) for checking the data integrity. In addition, the testing of the logical functions by means of targeted inputs and checking of the outputs is also considered as a measure.

A further diagnostic measure with which the functional safety can be increased consists in monitoring operating current strengths and operating voltages in order to recognize any anomalies in good time—or at all. The temperature of critical components can likewise be monitored in order to prevent any overheating damage.

The functional safety can also be increased by recording error events and system states for diagnosis and analysis after an error event (“logging”). By not only detecting faults but also identifying their causes, future faults can possibly be avoided.

A further measure for increasing the functional safety consists in the regular execution of diagnostic routines which check the functionality of individual components and, if necessary, initiate maintenance measures. Such a continuous monitoring and diagnosis can in this case be carried out during operation (“online”) without interruption of the normal functions.

By combining these measures and diagnoses, systems can meet the requirements for functional safety according to SIL2 and SIL3 by minimizing the probability of dangerous failures and ensuring the recognition and reaction to faults.

The functionally safe formation of an input can require the use of a communication protocol with which the previously listed errors can be recognized. If a communication protocol did not recognize the mentioned errors, a safety system could not trust the received signals and the data transmitted therewith. If, for example, it could not be guaranteed that the probability for an external signal introduced via an input lies below a certain acceptable threshold, then a safety system could not provide the evidence required for a certain safety integrity level about the failure safety of a safety function. Although it could of course be the simplest way to handle any communication via functionally safe communication protocols, this could be associated with disproportionately high costs. Due to the fact that it may be that only a certain part of the communication in process engineering plants must meet particularly high requirements with respect to the failure safety, a standard communication protocol can in principle be used in process engineering plants and this can only be supplemented at the relevant points by a functionally safer communication protocol based on the standard communication protocol; the underlying standard communication protocol can in this case be referred to as a “black channel”. The standard communication protocol can in this respect be, for example, the Profibus protocol, an Ethernet protocol or an Industrial Ethernet protocol based thereon, such as the Profinet protocol. In addition, however, any other conceivable communication protocol can also be used; in particular, the signal transmission can take place on the physical layer (“PHY” for short) of such a communication protocol, for example, in a wired or wireless manner, but also using an optical waveguide.

The functionally safe communication protocol based on a standard communication protocol can use various measures in order to recognize the previously listed errors which can occur during the reception of electrical signals by the electronic monitoring device. Thus, for example, an erroneous reception sequence of transmitted data packets can be excluded by the transmitted data packets being consecutively numbered; in this manner, in addition, the loss of one or more data packets can also be detected. By the data packets being able to be provided with a unique transmitter and receiver identifier, for example, misrouted electrical signals can be recognized. For the recognition of erroneous components of a data packet which arise as a result of electromagnetic interferences or other influences, in addition, for example, a cyclic redundancy check (“cyclic redundancy check”; for short: CRC) can be used. These and further safety measures can for example be implemented in the PROFIsafe communication protocol or in a CIPsafety protocol. The use of the PPROFIsafe communication protocol together with any communication connection as an underlying “black channel” can lead to an input of the electronic monitoring unit configured in a “functionally safe manner”.

A “triggering of a switching function” can generally be understood to mean a signal which can trigger a switching function. Such a signal can consist in an active instruction for carrying out a switching function; alternatively, however, the signal can also consist in a change of an existing signal state. Thus, the triggering of a switching function can be brought about, for example, in that an operating voltage or operating current strength of an electric actuator previously kept at a constant value is set to the value zero. The signal for “triggering a switching function” can be output at an output configured in a functionally safe manner of the electronic monitoring device.

Finally, the monitoring of an “operational relationship” between a check signal and a triggering of the switching function can be understood to mean the checking, determination and/or determination of a causal relationship between the two signals.

The monitoring of an operational relationship by an electronics system of the electronic monitoring device can consist, for example, in the checking whether the output of a signal for triggering the switching function precedes the reception of a check signal in terms of time. Although a check signal is received, but there is no temporally preceding triggering of the switching function, the electronic monitoring device can establish the absence of an operational relationship. This can be attributed, for example, to the fact that the check signal was erroneously generated by a sensor, although no switching function was triggered. Conversely, although a signal for triggering the switching function is present, but no check signal follows, an operational relationship can likewise be absent. This can be attributed, for example, to the fact that, although a switching function was triggered, the electric actuator does not execute the switching function. In the case of a solenoid valve test, this can be attributed, for example, to the fact that there is a problem with the electromagnet of the solenoid valve. The absence of a check signal despite a previously output signal for triggering a switching function can represent a safety-critical situation: even if this can possibly be attributed only to a faulty connection between the at least one sensor and the electronic monitoring device, the cause of the absence of a check signal can also be a functional failure of the electric actuator. If both a signal for triggering a switching function and a check signal are received, the monitoring of an operational relationship can consist, for example, in the determination of a time offset between the time of the output of the signal for triggering a switching function and the time of the reception of the check signal. Likewise, the monitoring of an operational relationship can comprise, in addition to the actual determination of an offset, also the comparison of the determined offset with an earlier or manufacturer-stored reference value for the offset and/or an earlier determined value for the offset. The correspondence of a determined value for the offset with a reference value or an earlier determined value for the offset can indicate, for example, a correct functioning of a safety function. Likewise, in the event of the output of the signal for triggering a switching function and the reception of a check signal, the monitoring of an operational relationship can consist in a comparison of information which may comprise the signal for triggering a switching function with information which may comprise the check signal. If the signal for triggering a switching function may comprise, for example, information with regard to the duration of the intended duration of the execution of a switching function, this duration can be compared with the actual duration of the execution of a switching function. If, for example, a solenoid valve test is carried out as a switching function, but takes longer than intended, the electronic monitoring device can establish a non-operational relationship despite the execution. The electronic monitoring device can also establish a non-operational relationship in the event that the check signal indicates a non-uniform execution of a switching function, such as, for example, a highly fluctuating speed of the movement of a component of a solenoid valve in a solenoid valve test, which does not agree with a time-speed profile to be expected according to the trigger signal. More generally, the monitoring of an operational relationship between a trigger signal and a check signal can consist in that the signals are examined for the presence of specific patterns, wherein, for example, the presence of a specific pattern or the presence of a specific sequence of a plurality of specific patterns indicates the presence of an operational relationship. Likewise, the presence of other specific patterns can also indicate the absence of an operational relationship. The examination of the signals for the presence of specific patterns can take place, for example, by the signals being compared with previously known patterns. In addition to these examples, the monitoring of an operational relationship between a received signal for triggering a switching function and a check signal received via an input of functionally reliable design can also consist in other comparisons between the signal for triggering a switching function and the check signal. The determination of an operational relationship between a check signal and a signal for triggering a switching function can serve as proof that a safety-instrumented function, which may comprise the control valve, meets certain requirements for failure safety, such as, for example, the requirements according to SIL1, SIL2, SIL3 or SIL4. If such evidence is transmitted to the safety system, then the safety system—with knowledge of the SIL levels of the other components of a safety-instrumented function—can document that a safety-instrumented function corresponds to the requirements of a certain SIL level.

A “limit contactor”, which can also be referred to as an “end position switch”, can in this case be understood to mean, in the context of control valves, a sensor which, in the form of a binary signal, gives feedback about the reaching of an upper or lower end position by the valve spindle. Limit contactors can play an important role in particular in the carrying out of partial-stroke and full-stroke tests: Even if a limit contactor does not deliver any information whatsoever about the course of the execution of a partial-stroke or full-stroke test, it can nevertheless reliably provide information as to whether the valve spindle has at least set itself in motion. In general, the control valve can comprise further sensors in addition to a limit contactor, with the result that-as already explained further above-the check signal describing the execution of the test function can also comprise further data of other sensors in addition to the data generated by a limit signal transmitter.

A “pressure sensor” can be understood to mean, in the context of control valves with a pneumatic drive, a sensor which gives feedback about the pressure prevailing in a chamber of the pneumatic drive as well as about pressure changes and/or pressure fluctuations.

A “stroke sensor” can be understood to mean, in the context of control valves, a sensor which determines the stroke of a closure element in the interior of the control valve.

A “SIL, certification” of a component can in this case be understood to mean—independently of stroke sensors—a confirmation that a proof has been provided for the relevant component that the failure probability thereof lies within certain predefined limits. In order that a safety-instrumented function consisting of different components as a whole can meet certain requirements for the failure safety, all components of the safety-instrumented function can have to meet the respective requirement for the failure safety. In other words: that component of a safety-instrumented function with the highest probability of failure (i.e. with the lowest SIL level) can determine the probability of failure of the safety-instrumented function as a whole. If exclusively components with SIL3 certification (probability of failure in case of need of >=10⁻⁴ to <10⁻³) are used in a safety-instrumented function, for example, with the exception of a component which meets a SIL2 certification (probability of failure in case of need of >=10⁻³ to <10⁻²), then the safety-instrumented function as a whole can nevertheless only achieve a SIL2 certification; the one component with SIL2 certification can form the “weakest link” within the safety-instrumented function with respect to the failure safety.

An “Ethernet Advanced Physical Layer (APL) connection” can in this respect be understood as a configuration—considered in the OSI model—of the lowest protocol layer, namely the physical layer (“PHY” for short), of an Ethernet protocol, which is specifically tailored to the requirements of process engineering plants. Ethernet protocols from the family of the IEEE standards 802.3 are in principle a definition of the configuration of the first protocol layer (“PHY” for short)-considered in the OSI model-and of the second protocol layer (“data link layer”) located directly thereabove. In addition to the transmission medium and the plug-in connections, the first protocol layer also specifies, inter alia, the coding. An “Ethernet APL” is in this respect understood as meaning a special Ethernet protocol from the family of the IEEE standards 802.3; this special Ethernet protocol differs from other Ethernet protocols exclusively in the lowest protocol layer, for which reason the terms “Ethernet APL connection” and “Ethernet APL connection” can also be used. In addition to the provision of current and communication signals via a single 2-wire cable, an Ethernet APL connection and an Ethernet APL connection can be designed, under the aspect of intrinsic safety, primarily for operation within explosion-endangered areas, which is a substantial requirement in particular in the process industry.

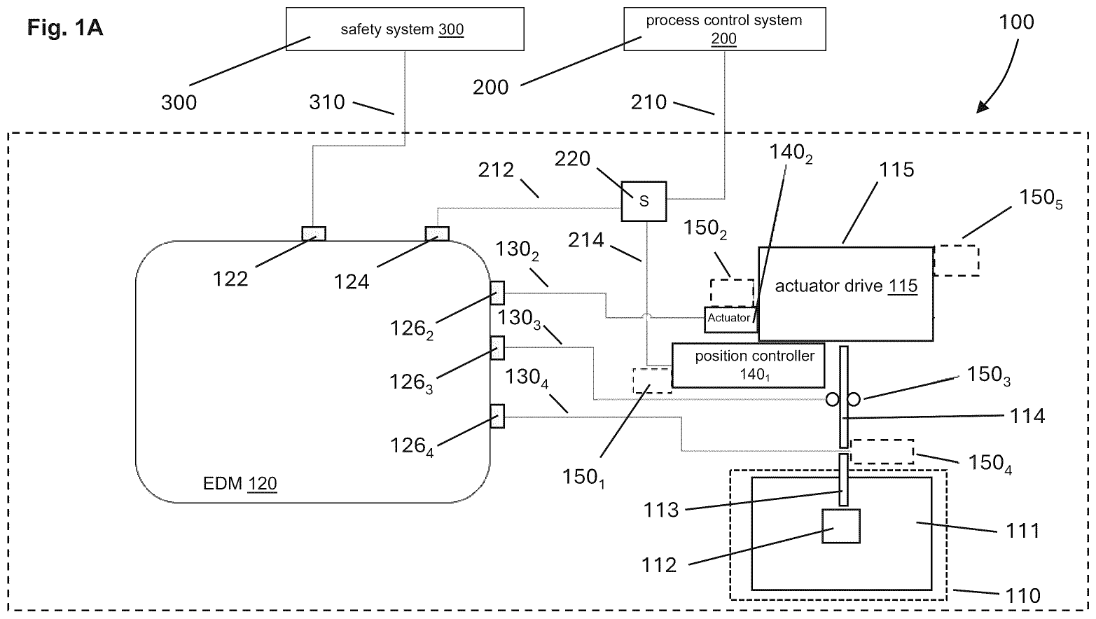

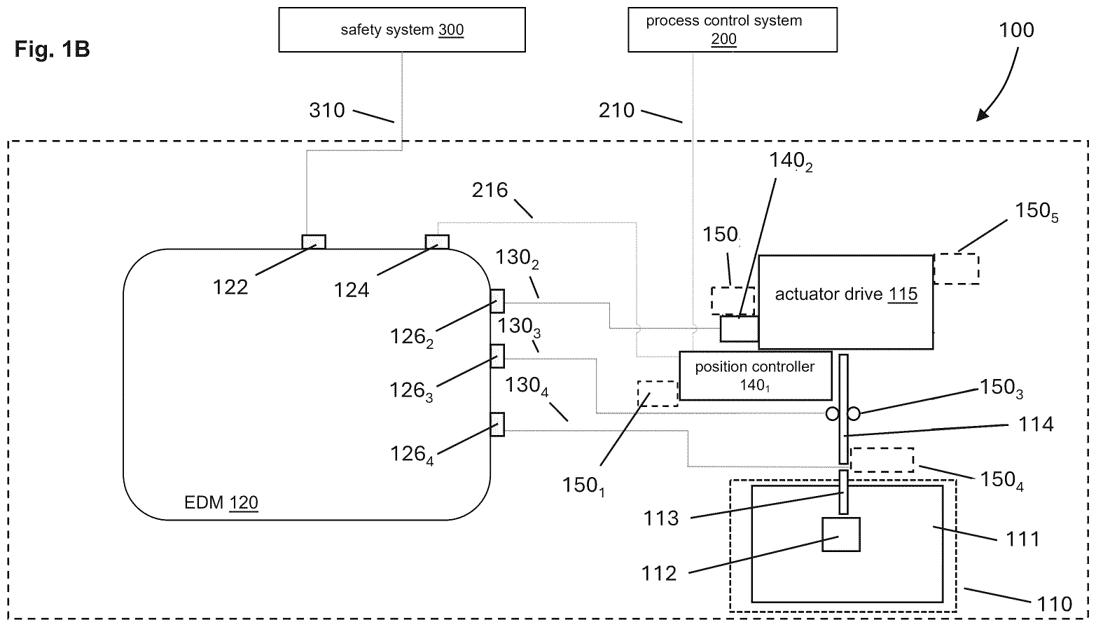

FIG. 1A shows an exemplary embodiment of an actuator device (100) which is connected to a process control system (200) via a connection (210) and is additionally also connected to a safety system (300) via a further connection (310). Each of the connections (210, 310) can—independently of the respective other connection—consist of one or more lines. Furthermore, each of the connections (210, 310)—independently of the respective other connection—can serve exclusively for communication. In addition, each of the two connections (210, 310)—independently of the respective other connection—can serve for the energy supply of the actuator device or of a part of the actuator device. Each of the two connections (210, 310) can—independently of the respective other connection—be, for example, a Profibus connection, an Ethernet connection or an Industrial Ethernet connection based thereon, such as, for example, a Profinet connection or an Ethernet APL connection.

According to the illustration, the actuator device (100) may comprise a control valve (110) and an electronic monitoring device (120) formed separately from the control valve, which is connected to the control valve according to the illustration via a plurality of connections (130₂, 130₃, 130₄). Each of the connections (130₂, 130₃, 130₄) can—independently of the respective other connections—consist of one or more lines. Furthermore, each of the connections (130₂, 130₃, 130₄)—independently of the respective other connections—can serve exclusively for communication. In addition, each of the connections (130₂, 130₃, 130₄)—independently of the respective other connections—can serve for the energy supply of the control valve or of a part or add-on part of the control valve.

The control valve (110) may comprise—according to the illustration viewed from bottom to top—the actual valve body (111) and, in the interior thereof, the valve cone (112) which, according to the illustration, is located in a lower end position, which means that the control valve is closed. The valve spindle (113) adjoins the upper end, according to the illustration, of the valve cone (112); at its upper end according to the illustration, said valve spindle is in turn connected to the drive spindle (114) which, for its part, produces the connection to the actuator drive (115) which, according to the illustration, is an inversely acting pneumatic diaphragm drive. As can be seen in FIG. 1A, the actuator drive consists of two chambers, wherein springs are arranged in the upper chamber according to the illustration. This arrangement leads to the control valve (110) being opened increasingly further with rising pressure in the actuator drive (115); conversely, this means that the actuator drive (115) leads to a closed control valve (110) in the completely vented state.

According to the illustration, the control valve (110) is equipped with a plurality of actuators (140₁, 140₂). These are drive elements which convert input signals into mechanical movements or into the change of physical variables as output signals. Depending on the type of the input signal and/or of the output signal, actuators can be divided into different categories, such as, for example, mechanical, acoustic, thermal or pneumatic actuators. According to the illustration, the actuator (140₁) is a position controller which can comprise one or more actuators, such as, for example, an I/P converter and/or a solenoid valve, while the actuator (140₂) is an independent solenoid valve independent of a position controller.

The position controller (140₁) is connected to the process control system (200) via the connection (214) which, according to the illustration, transitions upwards (“upstream”) into the connection (210). The position controller (140₁) receives instructions from the process control system as a reference variable with respect to the position of the control valve or of the valve spindle (113) which is to be set. The position controller (140₁) compares the actual position of the control valve or of the valve spindle with this reference variable and changes the control pressure with the aim of minimizing existing deviations between the reference variable and the controlled variable. In addition to this, the position controller (140₁) reports the current position of the control valve or of the valve spindle (113) back to the process control system. The instructions received from the position controller (140₁) with respect to the position of the control valve or of the valve spindle which is to be set can also be the subject matter of the triggering of a test function. In this case, the position controller (140₁) receives from the process control system (200) a trigger signal which is conducted via a switch (220) to the branch (212) and/or also to an electronic monitoring device (120) and is received there at an input (124). The connection (210) and the two branches (212, 214) do not have to be configured in a functionally safe manner in this case. The switch can—if the connection (124) functions as an output—also be designed such that it switches a signal from the electronic monitoring device (120) to the position controller (140₁).

The independent solenoid valve (140₂) is connected via a connection (130₂) to an output (126₂) configured in a functionally safe manner of the electronic monitoring device (120).

According to the illustration, the control valve (110) is furthermore equipped with one or more sensors (150₁, 150₂, 150₃, 150₄, 150₅), which can be arranged at different positions of the control valve and can be provided for monitoring different parameters. Thus, the sensor (150₃) can be, for example, a limit contactor. According to the illustration, this is connected via a connection (130₃) to an input (126₃) configured in a functionally safe manner of the electronic monitoring device (120). According to the illustration, a further sensor (150₄), which can be, for example, a position sensor, is connected via a connection (130₄) to a further input (126₄) configured in a functionally safe manner of the electronic monitoring device (120). The sensor (150₄) can alternatively also be any other sensor, such as, for example, a stroke sensor. Likewise, the sensors—as indicated by way of example by the position of the sensor (150₅)—can be arranged at any other points of the control valve. These sensors are likewise each connected to a further input configured in a functionally safe manner of the electronic monitoring device (120); however, the connection then to be designated as (150₅) and the input configured in a functionally safe manner to be designated as (126₅) were not illustrated in FIG. 1A for reasons of clarity. Furthermore-as indicated by way of example by the positions of the sensors (150₁, 150₂)—the actuators (140₁, 140₂) themselves can also be equipped with one or more sensors, which would then likewise have to be connected to functionally safe inputs of the electronic monitoring device (120) via corresponding connections.

According to the illustration, in addition to the input (124), which is not necessarily configured in a functionally safe manner and via which a trigger signal for a test function can be received, and in addition to the inputs (126₃, 126₄), which are configured in a functionally safe manner and via which check signals can be received from the sensors, the electronic monitoring device (120) also may comprise a connection (126₂), which is configured in a functionally safe manner and is connected to the independent solenoid valve (140₂) and can be formed as an output (126₂) in the present exemplary embodiment. In addition, the electronic monitoring device can comprise a further connection (122) configured in a functionally safe manner, which can simultaneously function as an input and as an output. Via this connection (122), the electronic monitoring device (120) can, on the one hand, be supplied with energy and/or data by the safety system (300); on the other hand, the electronic monitoring device (120) can, for its part, transmit information about the presence of an operational relationship between a check signal and a triggering signal to the safety system (300) via this connection (122). The presence of an operational relationship between a check signal and a triggering signal can serve, for example, as proof that a safety-instrumented function meets certain requirements for the failure safety.

The usability of information about the presence of an operational relationship for assessing the failure safety depends here decisively on the fact that the inputs (126₃, 126₄), via which the electronic monitoring device (120) receives check signals from the sensors (150₃, 150₄), are designed to be functionally reliable: only if it is ensured that the probability for erroneous signals lies below a specific threshold can a reliable statement about the presence of an operational relationship be made at all. However, a reliable statement obtained in this manner, which is determined by the electronic monitoring device (120), must reach the safety system (300) in an equally reliable manner: It is only in the safety system (300) that it can be assessed whether a safety-instrumented function in its totality meets certain requirements for the failure safety. Due to the fact that the failure safety of a safety-instrumented function is limited by that component of the safety-instrumented function which has the highest probability of failure (i.e. the lowest SIL level), the communication of the electronic monitoring device (120) with the safety system (300) must also take place via a connection (122) configured in a functionally safe manner. If the electronic monitoring device (120) determines, through the use of inputs (126₃, 126₄) configured in a functionally safe manner, for example for a certain part of the control valve, a failure safety which meets the requirements according to SIL3, then this proof would be worthless if it were transmitted to the safety system (300) via a connection (122) which only meets the requirements according to SIL2. Only the combination of inputs (126₃, 126₄) configured in a functionally safe manner and a connection (122) configured in a functionally safe manner allows the safety system (300) to use the proofs generated by the electronic monitoring device (120) through the monitoring of an operational relationship between a check signal and a triggering signal for an assessment of the functional safety.

The connections (210, 212, 214, 310) can be, for example, Ethernet APL connections, which can in particular be designed to be functionally safe; correspondingly, the connection (122) and the input (124) can also be formed as Ethernet APL connections. The Ethernet APL standard is in this respect a configuration of the Ethernet protocol which is specifically tailored to the requirements of process engineering plants and which differs from the usual Ethernet standard by a special configuration of the lowest protocol layer—considered in the OSI model—namely the physical layer (“PHY” for short). While, for example, the so-called fast Ethernet (100 Mbit/s) on the physical layer of generally eight existing twisted wire pairs uses only four wire pairs, in the case of the so-called gigabit Ethernet (1000 Mbit/s) all eight twisted wire pairs are required in order to be able to provide the higher transmission speed. Contrary to this fundamental trend to an ever higher transmission speed, in the case of Ethernet APL only a single twisted wire pair is used, which limits the transmission speed to 10 Mbit/s. Compared with conventional communication protocols which are usually used in the process industry and with which generally only transmission speeds in the range of a few kbit/s can be achieved, the-compared with the requirements for modern wired network low transmission speed of 10 Mbit/s-nevertheless represents an enormous increase. In view of the fact that no large amounts of data are transmitted via the connections (210, 212, 214, 310), the transmission speed of only 10 Mbit/s is completely sufficient. In the context of process engineering plants, high requirements for safety take the place of as high a transmission speed as possible. Thus, in the case of the energy supply of electrical and electronic devices in the Ex-Zone 0 or the Ex-Zone 1, it has to be ensured that the current intensities and voltages are limited such that, even in the presence of an ignitable or even explosive mixture, no ignition source arises which could lead to an ignition or even to an explosion. An electrical or electronic device or an electrical connection which-depending on the respective Ex-Zone-meets these requirements is referred to as intrinsically safe (“intrinsic safe”; Ex-i for short). Ethernet APL meets these requirements for intrinsic safety and is therefore designed for operation within explosion-endangered areas, which is a substantial requirement in particular in the process industry.

The connections (130₂, 130₃, 130₄, 210, 212, 214, 310) and the associated connections (126₂, 126₃, 126₄, 122, 124) can furthermore be of functionally reliable design. With respect to the connections, the functionally safe formation can be achieved by various circuit measures and diagnostic measures which have already been explained in detail further above. At the level of the communication protocols, certain requirements for functional safety can be met by a functionally safe communication protocol being superimposed on a non-functionally safe communication protocol, which is referred to as a “black channel”. An example of a functionally safe communication protocol which can be superimposed on the Ethernet APL connection is the PROFIsafe communication protocol or a CIPsafety protocol.

FIG. 1B shows an exemplary embodiment of an actuator device (100) which, with the exception of a different type of connection of the actuator device (100) to the process control system (200) and the associated changed possibilities, can correspond to the exemplary embodiment of an actuator device (100) illustrated in FIG. 1A. While, according to the illustration, the connection (210) can branch downwards (“downstream”) into a connection (212) and a connection (214) in FIG. 1A, such a branching can be absent in the actuator device illustrated in FIG. 1B. This can have the consequence that initially only the position controller (140₁)-but not the electronic monitoring device (120)—receives a trigger signal from the process control system (200). However, this trigger signal can subsequently be forwarded by the position controller (140₁) via a connection (216) to an electronic monitoring device (120) and received there at an input (124). The connection (210) between the process control system (200) and the position controller (140₁) and the connection (216) between the position controller (140₁) and the electronic monitoring device (120) do not have to be configured in a functionally safe manner in this case. Such a requirement of a functionally safe formation of the connection would be due to the fact that neither the outputs of the sensors (150₁, 150₂, 150₃, 150₄, 150₅) nor the outputs of a position controller (140₁) or of the solenoid valve (140₂) are generally configured in a functionally safe manner, since a functionally safe formation of these components would be associated both with a high structural and financial outlay. In the case of advanced sensors, position controllers or solenoid valves which, contrary to the rule—themselves have outputs configured in a functionally safe manner, the connections between these and the electronic monitoring device (120) can also be configured in a functionally safe manner. Independently of whether the connection is configured in a functionally safe manner or not, the connections (126₂, 126₃, 126₄) can generally be configured in a functionally safe manner.

The type of connection of the actuator device (100) to the process control system (200) according to the exemplary embodiment illustrated in FIG. 1B can additionally allow a modified mode of operation. Whereas the trigger signal can originate in each case from the process control system (200) both in the exemplary embodiment illustrated in FIG. 1A and in the exemplary embodiment illustrated in FIG. 1B, the exemplary embodiment illustrated in FIG. 1B can allow a trigger signal to originate from the safety system (300) and to be received at the input (122) of the electronic monitoring device (120). Subsequently, the trigger signal can be forwarded, for example, via a connection (124) acting as an output to an electric actuator (140₁).

The electronic monitoring device (120) can comprise an optional modular addition.

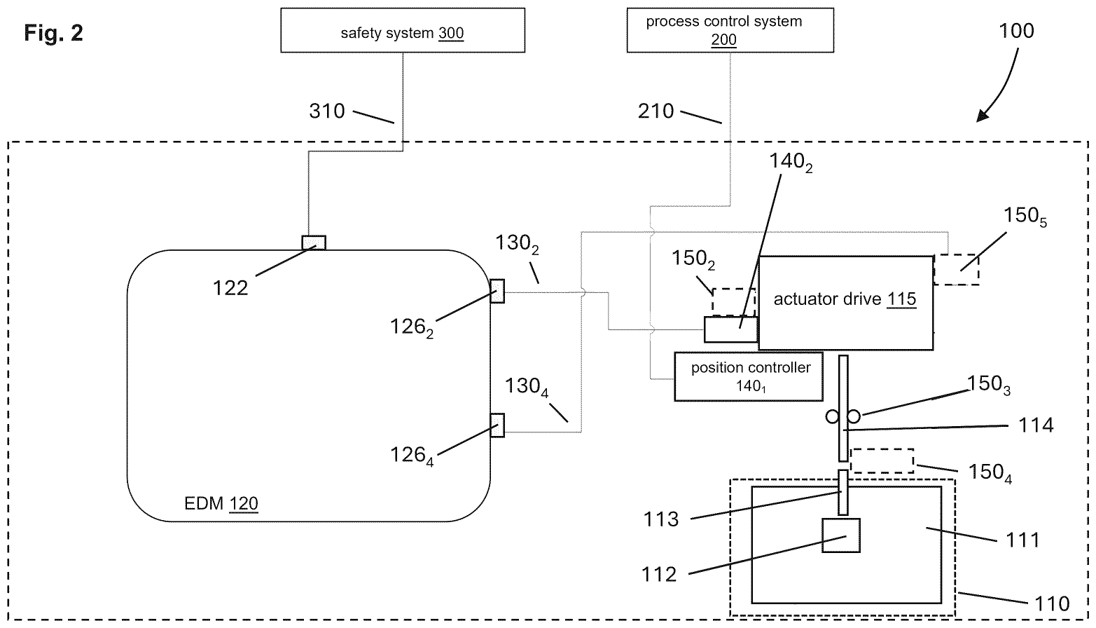

FIG. 2 shows an exemplary embodiment of an actuator device (100) which can execute a switching function for checking the switching capability of an electric actuator, such as a solenoid valve. The exemplary embodiment of an actuator device (100) illustrated in FIG. 2 differs from the exemplary embodiment illustrated in FIG. 1A by a reduced complexity. In contrast to the exemplary embodiment from FIG. 1A, the connection (130₂) between the actuator (140₂) and the connection (126₂) can be bidirectional; this can mean that the connection (126₂) can function both as an output and as an input. The electronic monitoring device (120) can trigger a checking of the switching capability of an electric actuator, such as, for example, the independent solenoid valve (140₂), via the output (126₂) configured in a functionally safe manner. Such a checking of the switching capability of the independent solenoid valve (140₂) can be, for example, a solenoid valve test. The electronic monitoring device (120) can receive a check signal via one or more sensors, such as, for example, a pressure sensor (150₅), which is connected to a functionally safe input (126₄) via a connection (1304). In the case of an actuator device (100) as in the exemplary embodiment illustrated in FIG. 2, a position controller (140₁) is not absolutely necessary and can be eliminated. The check signal can also originate from sensors other than the pressure sensor (150₅), such as, for example, from stroke sensors (150₄) or limit contact sensors (150₃). Furthermore, the pressure sensor (150₅) can also be arranged at different other positions (150₂, 150₄). All the other components can have the same function and properties as in the exemplary embodiments which have been described with reference to FIGS. 1a and 1b.

The features disclosed in the preceding description of the figures can be significant both individually and in any combination for the implementation of the disclosure in the various embodiments.

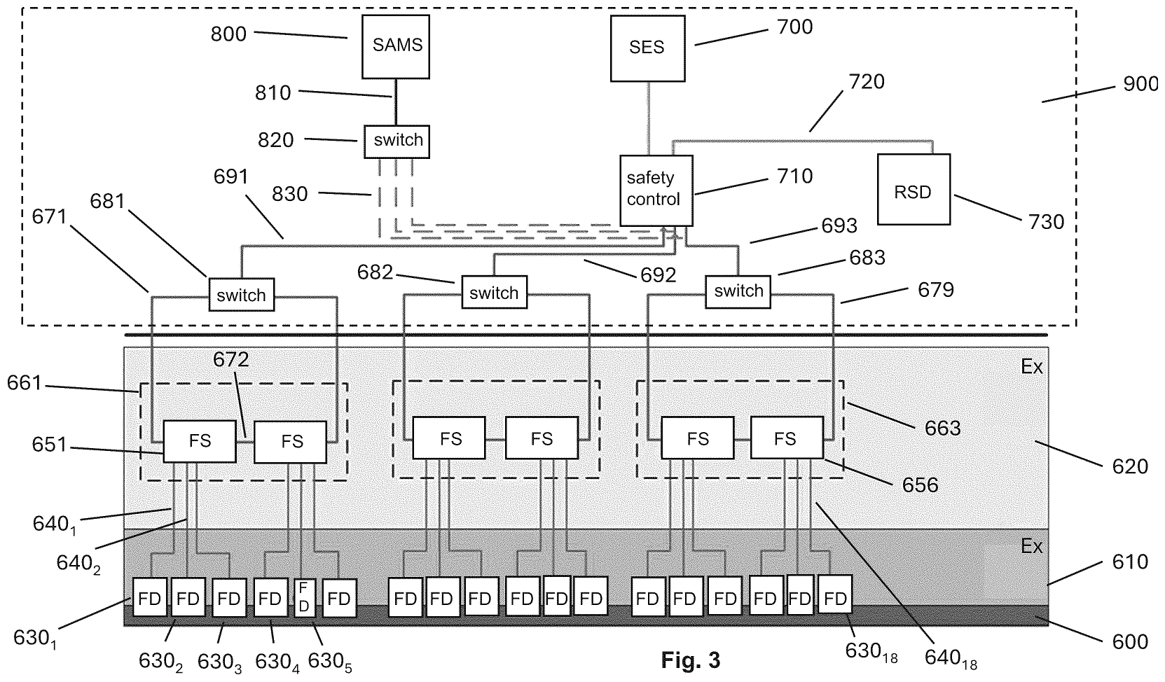

FIG. 3 shows a schematic illustration of selected components of a safety system of a process engineering plant and their assignment to zones at different levels of explosion endanger. An Ex-Zone 0 (600) is, according to the Operational Safety Ordinance (BetrSichV) and the Hazardous Materials Ordinance (GefStoffV), an area in which a dangerous explosive atmosphere as a mixture of air and combustible gases, vapors or mists is present constantly, over long periods of time or frequently. An Ex-Zone 1 (610) is likewise, according to the Operational Safety Ordinance (BetrSichV) and the Hazardous Materials Ordinance (GefStoffV), an area in which, during normal operation, a dangerous explosive atmosphere as a mixture of air and combustible gases, vapors or mists can occasionally form. Furthermore, an Ex-Zone 2 (620) is, according to the Operational Safety Ordinance (BetrSichV) and the Hazardous Materials Ordinance (GefStoffV), an area in which, during normal operation, a dangerous explosive atmosphere as a mixture of air and combustible gases, vapors or mists does not normally occur, and if so, then only rarely and for a short time.

At the boundary between Ex-Zone 0 (600) and Ex-Zone 1 (610), different field devices (630₁-630₁₈) are arranged, each of which is connected via in each case one communication connection (6401-640₁₈) to one of a plurality of switches (651-656) which are located in the field and which can be referred to as “field switches”. The communication connections between the field devices and the field switches can use, for example, an Ethernet APL connection; in this case, the field switches (651-656) can be referred to, for example, as “API, field switches”. One or more of the field switches (651-656) can be combined to form one or more groups (661-663) which, according to the illustration, are indicated by dashed lines.

Each of the field switches (651-656) can be connected within one of the groups (661-663) to one or more other field switches located in the same group via communication connections (672, 675, 678). The communication connections (672, 675, 678) can use a communication protocol configured in a functionally safe manner; likewise, the communication connections (672, 675, 678) can use a combination of a communication connection configured in a non-functionally safe manner, such as, for example, an Ethernet APL connection, as a black channel and a communication protocol configured in a functionally safe manner based thereon, such as, for example, a PROFIsafe communication protocol or a CIPsafety protocol. Alternatively, or additionally, each of the field switches (651-656) can be connected via in each case one communication connection (671, 673, 674, 676, 677, 679) to a switch (681-683) located outside the explosion-endangered areas. The communication connections (671, 673, 674, 676, 677, 679) can also use a communication protocol configured in a functionally safe manner; likewise, the communication connections (671, 673, 674, 676, 677, 679) can use a combination of a communication protocol configured in a non-functionally safe manner, such as, for example, an Ethernet APL connection, as a black channel and a communication protocol configured in a functionally safe manner based thereon, such as, for example, a PROFIsafe communication protocol or a CIPsafety protocol.

According to the illustration, the switches (681-683) can be arranged outside (900) the explosion-endangered areas, which switches, for their part, are in turn connected via functionally safely formed communication connections (691-693) to a safety control (“safety process control logic”, SPLC for short) (710). Within the safety system, the safety control (710) is connected via a communication connection (720) having a protocol for the platform-independent exchange of data, such as machine data, to a redundant safety device (“dual check safety”, DCS for short) (730); a communication protocol used in this communication can be, for example, an “Open Platforms Communication Unified Architecture” (OPC UA) protocol. According to the illustration, the safety control (710) is superordinated by an instance having safety engineering software (“safety engineering software”, Safety ES for short) (700) for controlling and programming the safety control (710).

A safety asset management system (“safety AMS” for short) (800) can likewise be located outside (900) the explosion-endangered areas, which safety asset management system is connected via a standard communication protocol, such as, for example, an Ethernet communication protocol, to a switch (820). One or more connections (830) can exist between the switch (820) and the safety control (710).

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

The various components described herein may be referred to as “modules,” “units,” or “devices.” Such components may be implemented via any suitable combination of hardware and/or software components as applicable and/or known to achieve their intended respective functionality. This may include mechanical and/or electrical components, processors, processing circuitry, or other suitable hardware components, in addition to or instead of those discussed herein. Such components may be configured to operate independently, or configured to execute instructions or computer programs that are stored on a suitable computer-readable medium. Regardless of the particular implementation, such modules, units, or devices, as applicable and relevant, may alternatively be referred to herein as “circuitry,” “controllers,” “processors,” or “processing circuitry,” or alternatively as noted herein.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The following is a list of reference numerals/characters:
100 Actuator device
110 Control Valve
111 Valve body
red
113 Valve spindle
114 Drive spindle
115 Actuator drive
120 Electronic monitoring device
121 Modular addition to the electronic monitoring device
122 Connection (configured in a functionally safe manner)
124 Connection (not necessarily configured in a functionally safe manner)
1262 Connection (configured in a functionally safe manner)
126₃, 126₄ Inputs (configured in a functionally safe manner)
130₂-130₄ Connections (configured in a functionally safe manner)
132₂ Outgoing signal (functionally safe)
132₃, 132₄ Check signals (functionally safe)
132₅ Outgoing signal (non-functionally safe)
140₁ Actuator (position controller)
140₂ Actuator (solenoid valve)
150₁, 150₂, sensor
150₃ Sensor (limit signal transmitter)
150₄ Sensor
150₅ Sensor (alternative position)
200 Process control system
210 Connection (not necessarily configured in a functionally safe manner)
212 Connection (not necessarily configured in a functionally safe manner)
214 Connection (not necessarily configured in a functionally safe manner)
220 Switch
300 Safety system
310 Connection (configured in a functionally safe manner)
400 Execution of a test function (partial stroke test, full stroke test)
500 Execution of a test function (solenoid valve test)
600 Ex-Zone 0
610 Ex-Zone 1
620 Ex-Zone 2
630₁-630₁₈ Field devices
640₁-640₁₈ Communication connections
651-656 Field Switches
661-663 Groups of Field Switches
671 Communication connection (to outside the field; functionally safe)
672 Communication connection (within the field; functionally safe)
673 Communication connection (to outside the field; functionally safe)
674 Communication connection (to outside the field; functionally safe)
675 Communication connection (within the field; functionally safe)
676 Communication connection (to outside the field; functionally safe)
677 Communication connection (to outside the field; functionally safe)
678 Communication connection (within the field; functionally safe)
679 Communication connection (to outside the field; functionally safe)
681-683 Switches (outside the field)
691-693 Communication connections (outside the field; functionally safe)
700 Instance having safety engineering software
710 Safety control
720 Communication connection
730 Redundant safety device
800 Safety asset management system
810 Communication connection
820 Switch
830 Communication connections
900 Area outside explosion-endangered areas

1. An actuator device of a process engineering plant comprising:
a control valve including:
an electric actuator configured in at least one operating state for a safety function of the control valve, and
at least one sensor configured to check a switching capability of the electric actuator for the safety function and transmit a check signal describing the switching capability; and
an electronic monitoring device including:
an output configured in a functionally safe manner and to trigger, based on a trigger signal, a switching function of the electric actuator,
an input configured in a functionally safe manner to receive the check signal of the at least one sensor, and
an electronics system configured to monitor an operational relationship between the check signal and the trigger signal for the switching function.

2. The actuator device according to claim 1, wherein the electric actuator is a safety valve.

3. The actuator device according to claim 1, wherein, during the checking of the switching capability of the electric actuator, a position of an actuator of the control valve remains substantially unchanged during the triggering of the switching function.

4. The actuator device according to claim 1, wherein the electronic monitoring device is configured to be intrinsically safe.

5. The actuator device according to claim 1, wherein the electronic monitoring device is supplied with energy via an Ethernet Advanced Physical Layer (APL) connection.

6. The actuator device according to claim 1, wherein energy is supply to the electric actuator and/or the at least one sensor by the electronic monitoring device.

7. The actuator device according to claim 1, wherein the electronic monitoring device is connected to a safety system of the process engineering plant via an Ethernet Advanced Physical Layer (APL) connection.

8. The actuator device according to claim 1, wherein the at least one sensor is a pressure sensor.

9. The actuator device according to claim 1, wherein the at least one sensor is a limit contactor and wherein the control valve further comprising a stroke sensor.

10. The actuator device according to claim 1, wherein the triggering of a switching function of the electric actuator is a movement of a component of the actuator.

11. The actuator device according to claim 1, wherein the check signal describing the switching capability comprises information about a start, an end, and/or a course of the triggering of the switching function.

12. The actuator device according to claim 11, wherein the information about the course of the execution of the test functions indicates a switching of a limit contact, a duration until the switching of the limit contact, a duration until the switching and a duration until a switching back of the limit contact, an evaluation of a time course of a stroke movement, an evaluation of a completed stroke, an evaluation of a time course of a pressure, an evaluation of a pressure difference, and/or an evaluation of a pressure change rate.

13. The actuator device according to claim 1, wherein the monitoring of the operational relationship between the check signal and the trigger signal comprises a determination of a presence of a signal course in the check signal associated with the triggering of the switching function.

14. The actuator device according to claim 1, wherein the monitoring of the operational relationship between the check signal and the trigger signal comprises a determination of a time offset between the check and trigger signals, and a comparison of the time offset with a stored or earlier determined reference value.

15. The actuator device according to claim 1, wherein the electronic monitoring device comprises a connection, which is configured in a functionally safe manner, via which the electronic monitoring device is connected to a safety system.

16. The actuator device according to claim 15, wherein the connection comprises a combination of a functionally safe communication protocol and a communication connection acting as a black channel.

17. The actuator device according to claim 16, wherein the functionally safe communication protocol is a PROFIsafe protocol or a CIPsafety protocol.

18. A method for monitoring an actuator device of a process engineering plant, the actuator device including a control valve having an electric actuator provided in at least one operating state for a safety function of the control valve and at least one sensor configured to check a switching capability of the electric actuator for the safety function and to transmit a check signal describing the switching capability, the method comprising:
triggering, by an electronic monitoring device, a switching function of the electric actuator at an output configured in a functionally safe manner of the electronic monitoring device;
receiving, by the electronic monitoring device, a check signal of the at least one sensor at an input configured in a functionally safe manner of the electronic monitoring device; and
monitoring, by an electronic system of the electronic monitoring device, an operational relationship between the check signal and the triggering of the switching function.

19. An electronic monitoring device for an actuator device of a process engineering plant, the electronic monitoring device comprising:
an output interface configured in a functionally safe manner and to trigger a switching function of an electric actuator of the actuator device, which is provided in at least one operating state for a safety function of a control valve;
an input interface configured in a functionally safe manner and to receive a check signal of at least one sensor of the actuator device corresponding to the switching capability of the electric actuator for the safety function; and
an electronics system configured to monitor an operational relationship between the check signal and the triggering of the switching function, wherein the electronic monitoring device is formed separately from the electric actuator.

20. The electronic monitoring device according to claim 19, wherein the electronics system is configured in a functionally safe manner.
